(19) United States
(12) Patent Application Publication
(10) Pub. No.: US 2025/0075355 A1
(43) Pub. Date: Mar. 6, 2025

(54) Artificial Intelligence Image Monitoring Recycled Pressure Solute Diminished Liquid-to-gas Conversion Method

(71) Applicants: Charles H. Ng, Palo Alto, CA (US); Hokchung Ng, Toronto (CA)

(72) Inventors: Charles H. Ng, Palo Alto, CA (US); Hokchung Ng, Toronto (CA)

(21) Appl. No.: 18/241,896

(22) Filed: Sep. 4, 2023

Related U.S. Application Data
(60) Provisional application No. 63/434,088, filed on Dec. 20, 2022.

(51) Int. Cl. C25B 15/023; C25B 1/04; C25B 9/23; C25B 13/02; C25B 15/027; C25B 15/029; G06V 10/766; G06V 10/82; G06V 20/50

(52) U.S. Cl. CPC C25B 15/023; C25B 1/04; C25B 9/23; C25B 13/02; C25B 15/027; C25B 15/029; G06V 10/766; G06V 10/82; G06V 20/50; G06V 10/774

(57) ABSTRACT

Electron exchangers are placed in the conversion cell and divide it into cathode gas chamber, liquid conversion solution chamber filled with a liquid flow controller, and anode gas chamber. Voltage is applied to the electron exchangers to convert the liquid conversion solution to gases, releasing to the gas chambers. Under recycled gas pressure, liquid conversion solution with unwanted solutes is fed through a solute diminish device and a solute diminish layer at the liquid flow controller. Unwanted solutes are blocked by the solute diminish device and the solute diminish layer. Tracks and puncture channels on the liquid flow controller are designed by critical surface calculations and manufactured with a precision technology. A computing engine connected to the cloud carries out artificial intelligence calculations, and controls valves, sensors, cameras, and gas flow devices. In producing the final gases, our method is energy efficient.

### CROSS-REFERENCE TO RELATED APPLICATIONS

This application claims the benefit of Provisional Patent Application Ser. No. U.S. 63/434,088 filed Dec. 20, 2022 by the present inventors, which is incorporated by reference in its entirety.

### TECHNICAL FIELD

The present invention relates to liquid to gas conversion method with an electrical voltage, specifically to such a method which is energy efficient.

### BACKGROUND ART

It is known in the prior art that liquid-to-gas conversion is commonly achieved by the application of a voltage to a liquid conversion solution through two pieces of conductive materials to produce final gases. With two pieces of conductive materials immersed in the liquid conversion solution, as anode and cathode, the conductive materials are under direct contact with the liquid conversion solution. Electrons are exchanged between these conductive materials and the liquid conversion solution, and final gases are released as bubbles from the immersed conductive materials. The gases float upward from the liquid conversion solution to the gas chambers above. This prior process works with a liquid conversion solution low in unwanted solutes and is generally not energy efficient.

### SUMMARY

Our method provides an energy efficient liquid-to-gas conversion using artificial intelligence image monitoring recycled pressure solute diminished conversion cell.

### DRAWINGS—FIGURES

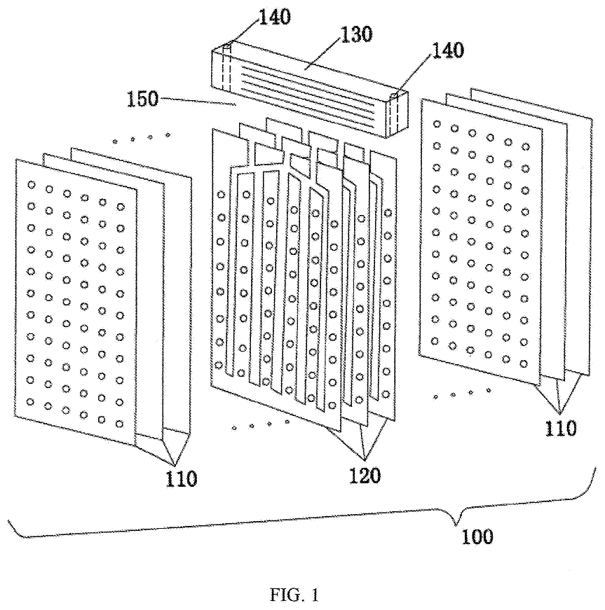

1) FIG. 1: Liquid flow controller, composed of solute diminish layer at one side and three types of liquid control single sheets stacked together next to solute diminish layer

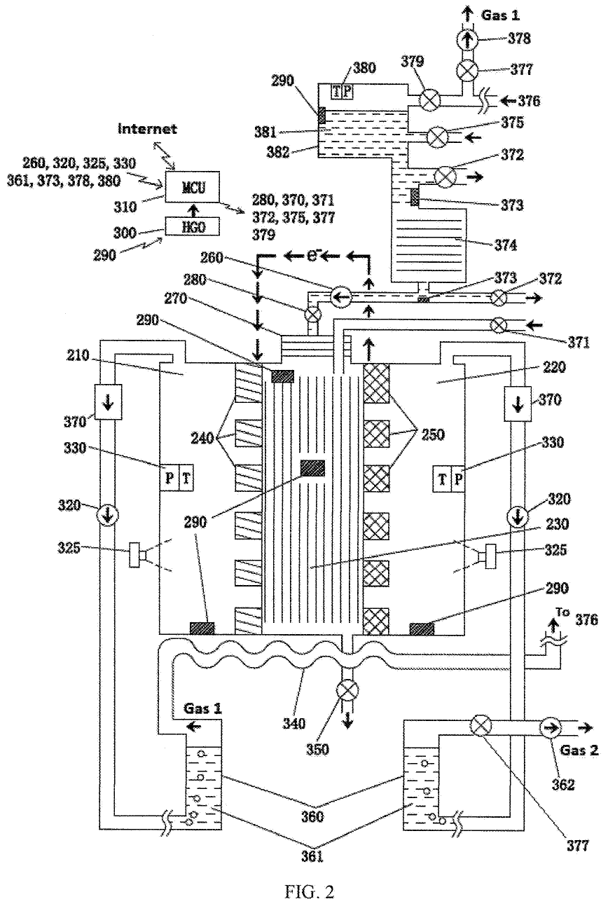

2) FIG. 2: Liquid-to-gas Conversion Cell

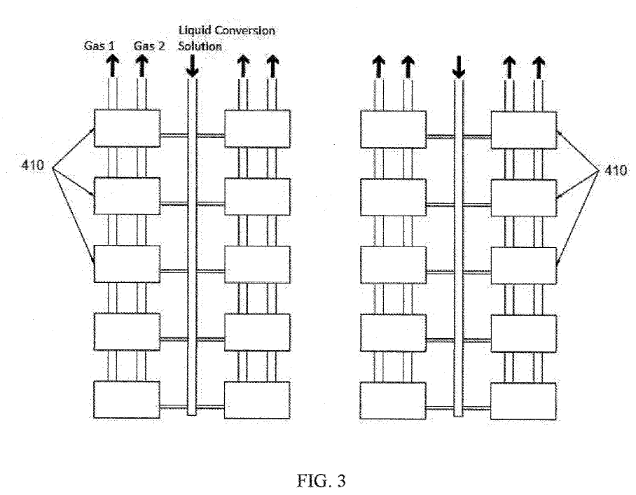

3) FIG. 3: Stacking of Conversion Cells

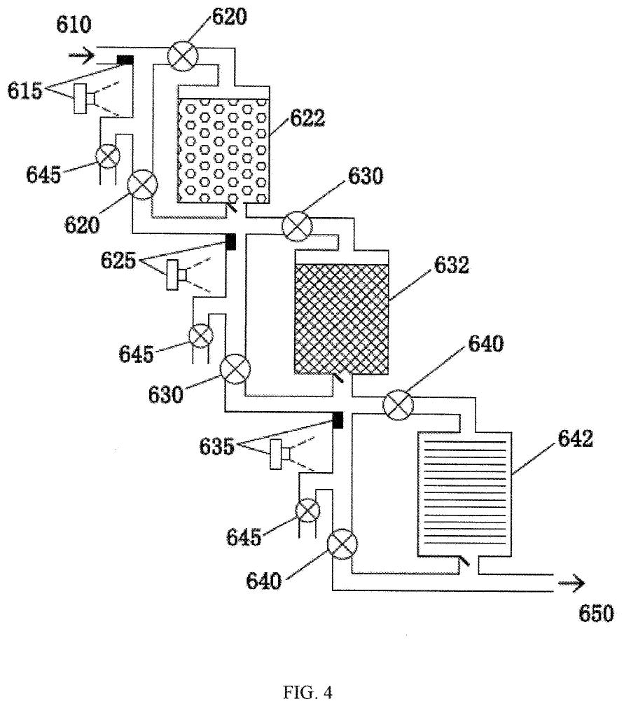

4) FIG. 4: Solute Diminish Device

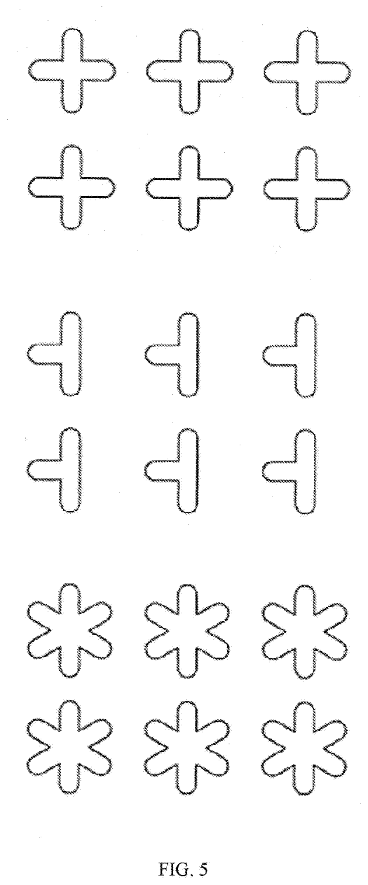

5) FIG. 5: Design patterns for puncture channels

### DRAWINGS—REFERENCE NUMERALS

100: Liquid Flow Controller
110: Part of the Liquid Control Sheet Stack: Combination of liquid control single sheets and liquid retention mesh material single sheets
120: Part of the Liquid Control Sheet Stack: Multiple Track Injection Single Sheets
130: Solute Diminish Layer
140: Ionizing Solute Inlets
150: Distribution Track for Distributing Liquid Conversion Solution Across Liquid Control Sheet Stack
210: Cathode Gas Chamber
220: Anode Gas Chamber
230: Liquid Conversion Solution Chamber Filled with the Liquid Flow Controller
240: Cathode Electron Exchanger
250: Anode Electron Exchanger
260: Liquid Flow Sensor
270: Solute Diminish Layer
280: Liquid Conversion Solution Liquid Flow Valve
290: Liquid Content Sensor
300: Hygrometer (HGO)
310: Microprocessor (MCU)
320: Gas Flow Sensor
325: Cameras monitoring Electron Exchangers and Gas Chambers
330: Temperature Sensor and Gas Pressure Sensor
340: Heat Exchange Device
350: Conversion Cell Self Clean Flushing Liquid Valve
360: Gas Cleaning Cell
361: Gas Cleaning Liquid
362: Final Output Gas Flow Sensor
370: Enhance Gas Flow Device
371: Ionizing Solute Inlet Liquid Valve
372: Liquid Conversion Solution Self Cleaning Liquid Valve
373: Resistivity Sensor and Optical Clearness Sensor
374: Solute Diminish Device
375: Liquid Conversion Solution Refill Liquid Valve
376: Gas Pipe Connection
377: External Gas Flow Valve Controls Recycled Pressure Gas to External Storage
378: Gas Flow Sensor for Recycled Pressure Gas to External Storage
379: Recycle Gas Flow Valve Controls Recycled Pressure Gas to Liquid Reservoir
380: Liquid Reservoir Temperature Sensor and Gas Pressure Sensor
381: Liquid Conversion Solution
382: Liquid Reservoir
410: Liquid-to-gas Conversion Cell
610: Liquid Inlet to Solute Diminish Device
615: Inlet to First Solute Diminish Cell. Resistivity Sensor, Optical Clearness Sensor, and Camera Target Area
620: Liquid Valves Controlling Flow for First Solute Diminish Cell
622: First Solute Diminish Cell
625: Inlet to Second Solute Diminish Cell. Resistivity Sensor, Optical Clearness Sensor, and Camera Target Area
630: Liquid Valves Controlling Flow for Second Solute Diminish Cell
632: Second Solute Diminish Cell
635: Inlet to Third Solute Diminish Cell. Resistivity Sensor, Optical Clearness Sensor, and Camera Target Area
640: Liquid Valves Controlling Flow for Third Solute Diminish Cell
642: Third Solute Diminish Cell
645: Liquid Valves for Self Clean Flushing
650: Liquid Outlet from Solute Diminish Device

### DESCRIPTION

Our method discloses an artificial intelligence image monitoring recycled pressure solute diminished liquid-to-gas conversion method.

The anode and the cathode electron exchangers are placed in the liquid-to-gas conversion cell, and the conversion cell is divided into, from left to right, the cathode gas chamber, the liquid conversion solution chamber filled with the liquid flow controller, and the anode gas chamber. See FIG. 2. One side of the electron exchanger faces the liquid conversion solution chamber in direct contact with the liquid flow controller, and this side is coated with non-conductive polymer material. The other side of the electron exchanger faces the gas chamber, and this side is conductive. The surface of the electron exchanger is covered with puncture channels. Voltage is applied to the anode electron exchanger and the cathode electron exchanger, and the liquid conversion solution is converted into final gases, which are released separately into the cathode gas chamber and the anode gas chamber. Gases pass through the two gas chambers outlets to the cathode and anode gas cleaning cells. Gas cleaning cells are filled with a gas cleaning liquid. Gas bubbles rise from the gas inlets of the gas cleaning cells to the gas outlets at the top of the gas cleaning cells.

The liquid-to-gas conversion cell is made to accept liquid conversion solution with a large amount of unwanted residues and solutes. The liquid flow controller is placed in the liquid conversion solution chamber. The liquid flow controller is made of a solute diminish layer at one side, a distribution track next to the solute diminish layer, and a liquid control sheet stack next to the distribution track. See FIG. 1.

The liquid conversion solution is fed from the liquid reservoir, through a solute diminish device, to the solute diminish layer of the liquid flow controller. The unwanted residues and solutes in the liquid conversion solution are first blocked by the solute diminish device, and again blocked by the solute diminish layer. After the solute diminish layer, the distribution track evenly distributes the liquid conversion solution and ionizing solute across the liquid control sheet stack.

The solute diminish layer is made of materials with very small pores that are just large enough for the liquid conversion solution molecules to pass through, and any other larger size organic and inorganic materials will be blocked. The pores size should be about two to five times the size of the liquid conversion solution molecule. As one of the embodiments of this liquid-to-gas conversion method, using water as the liquid conversion solution, the water molecule is around 0.3 nanometer wide, and hence the pores of the solute diminish layer should be around 0.6 nm to 1.5 nm, roughly two times to five times the size of a water molecule. This solute diminish layer can be made from sheets of grapheme, and sheets of grapheme oxide stacked together. Also, it can be made from stacking polymer particles that are coated with grapheme. The structure of these materials stacked together can provide pores size of around 0.6 nm to 1.5 nm, offering the appropriate size for the water molecules to pass through, and blocking anything else that is larger than this size.

An appropriate amount of necessary type of ionizing solute is maintained in the liquid conversion solution in order to ionize the molecules of the liquid conversion solution. A few ionizing solute inlets come in from the side of the liquid flow controller, pass through the solute diminish layer, and go directly to the distribution track. The ionizing solute inlets are protected from the solute diminish layer materials, and the necessary ionizing solute can be fed to the liquid flow controller without being blocked by the solute diminish layer.

The liquid control sheet stack is built by stacking together a plurality of three types of nonconductive single sheets. The first type of single sheet is a multiple track injection single sheet that has a number of tracks and puncture channels on the surface, and a number of liquid inlets at the side of this multiple track injection sheets. The tracks form a network of wide distribution channels from the liquid inlets to different locations across the single sheet. In addition to the tracks, the sheet surface is also covered with many puncture channels with design patterns, see FIG. 5. The second type of single sheet is a liquid control single sheet that has many puncture channels on the surface. The puncture channels have a specially designed pattern, see FIG. 5. The third type of single sheet is a liquid retention mesh material single sheet made of polymer or nylon meshed materials with a lot of pores. The first type multiple track injection single sheets are placed near the center of the liquid control sheet stack, and they are sandwiched from the left and from the right by a mixture of the second type liquid control single sheets and the third type liquid retention mesh material single sheets. The liquid control single sheets and the liquid retention mesh material single sheets protect against any gas bubbles getting through the multiple track injection single sheets in the middle.

When the first type and the second type single sheets are stacked together, the puncture channels on adjacent single sheets are kept out of alignment with each other. In other words, the puncture channels from adjacent single sheets are located at different positions from each other, and they are separated to form a pattern of interlocking channels. These interlocks enhance the ability of liquid conversion solution molecules to adhere to the multiple track injection liquid controller.

The first type multiple track injection single sheets and the second type liquid control single sheets are manufactured by a precision technology, comprising: chemical etching, plasma etching, laser drilling or electroforming process. The manufacturing of the single sheets can begin with conductive or nonconductive materials. The first option is chemical etching, which is a relatively low-cost process to make the desired single sheets. This chemical etching process can be applied to a piece of conductive material of the desired specification, and chemicals etch away specific spots of the material to form the tracks or puncture channels. For the second option, it is also possible to plasma etching on a nonconductive polymer material, and plasma etches away specific spots of the nonconductive polymer material to form the tracks or puncture channels. The third option is laser drilling, in which a piece of conductive or non-conductive material that meets the requirements is repeatedly applied with pulsing focused laser energy to cut through the material to form the tracks or puncture channels. A fourth option is electroforming, where nanometer scale or micrometer scale metal devices are fabricated by electrodepositing on a pattern called a mandrel. The desired conductive material is electrodeposited on the mandrel to form the single sheets, the tracks, and the puncture channels. If the making of the single sheets starts from a conductive material, after the puncture channels are made by one of the above processes, the surface of the conductive material is coated with a nonconductive polymer material, such as Titanium Carbide, to make the single sheets nonconductive.

The third type liquid retention mesh materials single sheet is nonconductive and is manufactured by precision material woven technology.

The combination of various physical parameters, the design of the liquid control sheet stack, the design of three types of single sheets, the stacking of the single sheets, the design of the multiple tracks, and the design of the puncture channels is the key to control the ability of the liquid conversion solution to adhere to the liquid flow controller, and to make the liquid conversion solution forming thin films on the single sheet critical surface. The thickness of the single sheet, the spacing between adjacent single sheets, the size of the multiple tracks, the size of the puncture channels, and the distance separating the channels should not be too large or too small, in the range of nanometers to micrometers, and should be calculated by the following method.

The liquid conversion solution stays on the critical surfaces of the single sheets as droplets. It will diffuse until a partial wetting equilibrium contact radius is reached. For a simple estimation calculation, the droplet radius r can be expressed as:

$$r = \sqrt{\frac{V}{π h}} , where h = \sqrt{\frac{2 σ ( 1 - cos θ )}{ρ g}}$$

σ is the surface tension
g is the gravitational acceleration constant
θ is the contact angle between the liquid and the surface
h is the height of the droplet
V is the time function of the volume of the droplet

Using a more detailed model and calculations, the change in droplet radius r(t) over time can be expressed as:

$$r ( t ) = {{r}_{e} [ 1 - exp ( - ( \frac{2 {γ}_{LG}}{{r}_{e}^{12}} + \frac{ρ g}{9 {r}_{e}^{10}} ) \frac{24 λ {V}^{4} ( t + {t}_{0} )}{{π}^{2} η} ) ]}^{\frac{1}{6}}$$

It is also possible to assume perfect spreading of the liquid conversion molecules and radius can be expressed as:

$$r ( t ) = {[ {( {γ}_{LG} \frac{96 λ {V}^{4}}{{π}^{2} η} ( t + {t}_{0} ) )}^{\frac{1}{2}} + {( \frac{λ ( t + {t}_{0} )}{η} )}^{\frac{2}{3}} \frac{24 ρ {gV}^{\frac{3}{8}}}{7 \cdot {96}^{\frac{1}{3}} {π}^{\frac{4}{3}} {γ}_{LG}^{\frac{1}{3}}} ]}^{\frac{1}{6}}$$

γLG is the surface tension of the liquid
V is the droplet volume
η is the viscosity of the liquid
ρ is the density of the liquid
g is the gravitational acceleration constant
λ is the shape factor, 37.1 m-1
t0 is the experimental delay time
re is the radius of the droplet at equilibrium

Assuming that the delay time is 0.1 to 2 seconds to calculate the droplet radius r,

The width of each track on the first type multiple track injection single sheet should be larger than r, this width should be set as 500% to 5,000% of r.

For the first type and the second type single sheet, the spacing between adjacent puncture channels should be set as 100% to 200% of the droplet radius.

For the first and second type single sheet, the radius of the puncture channel should be set as no larger than r.

The radius of the pores in the third type of liquid retention mesh material single sheet should be set as no larger than r.

In common liquid conversion solution materials, the width of the track can be from 500 micrometer to 5,000 micrometer, and the diameter of the pores and puncture channel can be from 100 nanometers to 100 micrometers. The size of the pores, the width of the multiple tracks, and size of the puncture channels can be adjusted based on the operating temperature, air pressure, as well as the desired gas production level.

On the same single sheet, the width of the track and the size of the puncture channel can be different. The size can be smaller or larger depending on whether their locations are closer to or farther away from the source of the liquid conversion solution.

For the three types of single sheet, the thickness and the distance between adjacent sheets can be calculated in the following:

The height h of a liquid column is given as

$$h = \frac{2 γ cos θ}{ρ g r}$$

γ is the liquid-air surface tension coefficient (force/unit length),
θ is the contact angle,
ρ is the density of liquid,
g is the gravitational acceleration constant, and
r is the radius of liquid column.

For the three types of single sheet, the thickness of the single sheets should be as no thicker than h. The thickness of the sheets is approximately equal to 100 nanometers to 100 microns in common liquid conversion solution materials. The thickness can be adjusted according to the operating temperature, air pressure, as well as the desired gas production level.

The spacing between adjacent single sheets should not be greater than 50% to 100% of h. In common liquid conversion solution materials, the spacing between individual sheets is approximately between 50 nanometers and 100 microns. The spacing can be adjusted according to the operating temperature, air pressure, as well as the desired gas production level.

The liquid conversion cell is equipped with an intelligent microprocessor (MCU) to carry out artificial intelligence machine learning calculation, and data is also transmitted to the local computing engine or to the cloud computing engine via the Internet for calculation. Microprocessor monitors and controls various operation parameters of the liquid-to-gas conversion cell.

The liquid flow valve feeds liquid conversion solution directly from the liquid reservoir at a higher level, through a solute diminish device, to the liquid inlets of the solute diminish layer at the liquid flow controller. The microprocessor controls the liquid flow valve and decides whether to increase or decrease the flow of the liquid conversion solution to the liquid flow controller.

The microprocessor is connected to cameras, resistivity sensors, optical clearness sensors, liquid content sensors, temperature sensors, gas pressure sensors, liquid pressure sensors, gas flow sensor, liquid flow sensor, voltage sensor, and current sensor. More sensors can be placed at selected locations within the conversion cell, the liquid reservoir, and the gas cleaning cells, if necessary. Each liquid content sensor has a pair of resistance probes to sense the resistivity and the liquid content of the liquid conversion solution at different locations in the conversion cell. The probes are made of anti-corrosion and anti-oxidation conductive materials, or they can be coated with highly conductive anti-corrosion and anti-oxidation materials to prevent the probe from oxidation over time.

The first liquid content sensor is placed on the liquid inlet side of the liquid flow controller, and the second liquid content sensor is placed near the middle of the liquid flow controller, in order to detect the resistivity and the liquid content of the liquid conversion solution in those locations. The microprocessor senses that the liquid content at these locations, it will increase the liquid flow valve when there is too little liquid, or decrease the liquid flow valve when there is too much liquid.

The third and fourth liquid content sensors are placed at the bottom of the cathode gas chamber, and the bottom of the anode gas chamber. If the microprocessor senses that there is a certain amount of liquid conversion solution at these locations, it means that there is too much liquid conversion solution entering the liquid flow controller, and the electron exchangers cannot keep up with the liquid-to-gas conversion. The microprocessor will decrease the flow valve to slow the liquid conversion solution flow to the liquid flow controller.

The microprocessor is connected to multiple temperature and pressure sensor that are placed inside or around the cathode gas chamber, the liquid conversion solution chamber, and the anode gas chamber. The microprocessor is connected to two gas flow sensors that are placed at the gas outlets from the cathode and anode gas chambers. Microprocessor connects to two enhance gas flow devices, such as electric gas flow fans, at the outlets from the two gas chambers, and controls the gas pressure coming from the gas chambers.

One of the two gases coming out from the gas cleaning cells is selected to be the recycled pressure gas. This recycled pressure gas is connected to the heat exchange device that is placed along the outside wall of the liquid-to-gas conversion cell, and especially outside and next to the cathode and anode electron exchangers. Through the heat exchange device, heat from the liquid-to-gas conversion process is absorbed by the recycled pressure gas. The absorbed heat helps to increase the gas pressure of the recycled pressure gas. The recycled pressure gas is connected from the outlet of the heat exchange device to two gas valves which are controlled by the microprocessor.

The first external gas valve directs the recycled pressure gas to external gas storage. The second recycle gas valve directs the recycled pressure gas to the liquid reservoir with the temperature and pressure sensors inside. When microprocessor senses the pressure inside the liquid reservoir is low, microprocessor opens the second recycle gas valve, closes the first external gas valve, and brings the recycled pressure gas into the air-sealed liquid reservoir to raise the gas pressure inside the liquid reservoir. As the pressure inside the liquid reservoir reaches the desired level, microprocessor closes the second recycle gas valve, and opens the first external gas valve that leads the gas to external gas storage.

The gas pressure pushes the liquid conversion solution from the liquid reservoir to flow through the solute diminish device, and continue to the solute diminish layer of the liquid flow controller. This gas pressure inside the liquid reservoir is very important in assisting the liquid conversion solution to pass through the solute diminish device and achieve the required level of liquid flow.

Microprocessor with the liquid content sensor monitors the liquid level inside the liquid reservoir, and if it is too low, microprocessor opens the valve to bring in more liquid conversion solution into the reservoir.

The solute diminish device is composed of three solute diminish cells to diminish the residues and solutes in the incoming liquid conversion solution. See FIG. 4. By the same principle, more solute diminish cells can be added to the solute diminish device. The first coarse diminish cell is filled with small diminish agent, such as pebbles, sand or equivalent materials. The second fine diminish cell is filled with very fine diminish agent, such as graphite, charcoal, or equivalent materials. The third extreme fine diminish cell is filled with extremely fine diminish agents, such as graphene, graphene oxide layers, or equivalent materials.

The liquid conversion solution enters the solute diminish device main inlet and goes to two separate valves, leading to the first coarse diminish cell, or bypassing the first cell and onto the outlet of the first cell. Liquid conversion solution leaves the first cell outlet and goes to two separate valves, leading to the second fine diminish cell, or bypassing the second cell and onto the outlet of the second cell. Similarly, liquid conversion solution leaves the second cell outlet goes to two separate vales, leading to the inlet of the third extreme fine diminish cell, or bypassing the third cell and onto the outlet of the third cell. Liquid conversion solution leaves the third cell outlet and onto the main outlet of the solute diminish device.

Three sets of resistivity sensor, optical liquid clearness sensor, and image cameras are connected to the microprocessor, and each set is located at the inlet of the each of the three solute diminish cells to monitor the status of the liquid conversion solution at these locations. Operation images from the cameras are sent to the microprocessor for artificial intelligence calculation.

Microprocessor controls the two valves at each of the inlets of the three cells, and controls the liquid conversion solution flowing into the diminish cell or bypassing the diminish cell. The microprocessor together with cameras using artificial intelligence to monitor and recognize the operating conditions of the incoming liquid conversion solution to each cell, and identify if the liquid conversion solution contains large, medium, or small size residues, and also the optical clearness of the liquid. If the size of residues matches the targeted size of the upcoming diminish cell, microprocessor directs the liquid to flow to the cell. If the residues are smaller than the targeted size, the microprocessor directs the liquid to bypass the cell and flow to the next cell. The design of the solute diminish device can be used as a standalone method to separate diminish residues and solutes in any liquid, and can be used independent of the liquid-to-gas conversion process.

The relative residue sizes and conditions in the liquid conversion solution are difficult to detect. There are image cameras monitoring the solute diminish cells inside the solute diminish device, and the operating conditions 1 to N include, but not limited to, different concentrations of different sizes of residues, different residue floating conditions, and different kinds of color or clearness that exist in the liquid. These operating conditions can be recognized from the camera images by the artificial intelligence convolution neural network calculations, and the results are fed to the machine learning regression analysis. Based on these conditions, microprocessor can change the flow of the liquid conversion solution through the three solute diminish cells in the solute diminish device.

The result is a large portion of the unwanted residues and solutes in the liquid conversion solution is blocked by the solute diminish device, and again by the solute diminish layer of the liquid flow controller, as the liquid conversion solution flows from the liquid reservoir through the solute diminish device to the liquid flow controller.

Microprocessor connects to multiple sets of cameras, electrical resistivity sensor, and optical clearness sensor that monitor the level of unwanted residues and solutes in the liquid conversion solution. As more liquid conversion solution flows through these locations, the amount of unwanted residues and solutes will build up because they are blocked from flowing through, and hence the resistivity and the optical clearness of the liquid at these locations both go down. These operating conditions can be recognized from the camera images by the artificial intelligence convolution neural network calculations, and the results are fed to the machine learning regression analysis. When the microprocessor with the cameras and sensors sense that the level of unwanted residues and solutes is too high, it opens up separate valves at these locations to flush out the unwanted residues in the liquid conversion solution, and lower the level of unwanted residues and solutes. Microprocessor controls liquid flow valve at the bottom of the liquid-to-gas conversion cell, and opens theses liquid valves when it is needed to flush out the liquid-to-gas conversion cell for self cleaning maintenance.

Complicated operating conditions at the cathode and anode electron exchangers, and at the gas chambers are difficult to detect. The microprocessor is connected to two image cameras in order to monitor and recognize the operation conditions of the cathode and the anode electron exchangers, and the gas chambers. Possible operating conditions 1 to N include, but not limited to, gas is not coming out from the electron exchangers, large amount of liquid is coming out from the electron exchangers, or overheating red hot electron exchangers. These operating conditions can be recognized from the camera images by the artificial intelligence convolution neural network calculations, and the results are fed to the machine learning regression analysis. Based on these operating conditions, microprocessor can increase or decrease the liquid flow valves, or controls the gas pressure at the liquid reservoir, allowing more or less liquid conversion solution from the liquid reservoir to flow into the liquid flow controller.

The microprocessor is connected to the voltage and current sensors to measure the electrical voltage and current applied to the cathode and anode electron exchangers.

Microprocessor with the sensors and cameras to monitor the temperature, gas and liquid pressure, liquid amount, liquid level, liquid resistivity and optical clearness, operating condition, voltage and current, gas and liquid flow rate, and required gas production output rate. Microprocessor controls the sensors, liquid flow valves, gas flow valves, enhance gas flow device, and hence controls the liquid and gas flow, liquid and gas pressure, liquid resistivity and clearness, and temperature inside the cathode gas chamber, liquid conversion solution chamber, anode gas chamber, liquid flow controller, liquid reservoir, solute diminish layer, and solute diminish device. All these controls results in improving the efficiency of the liquid-to-gas conversion cell.

More sensors in the conversion cell can be handled using a similar approach as described above. The microprocessor fast response speed is around one to two seconds and can control these devices and various parameters in real time.

The microprocessor sends the sensor data to the local wired or wireless network, and transmits the data to the cloud computing engine through the Internet to perform the artificial intelligence calculation and store the data in the cloud storage. Due to security concerns, these data can also be transmitted to the local computing engine through wired or wireless network, and the artificial intelligence calculations can be completed in the local computing engine.

The artificial intelligence computing engine calculates the control instructions from the analysis results, and transmits the control instructions to control various valves, sensors, and enhance gas flow devices. At the same time, operators in different remote locations can read the data and the artificial intelligence calculation results from the cloud server through mobile phones and computer tablets.

In setting up the artificial intelligence image calculation for the training session, 75% of the training image data set is taken as training samples, and the remaining 25% are used as test samples to evaluate the accuracy of the results. After completing the training of enough images, machine learning can predict, based on the new input image, the type of the new operating conditions. Training steps can be carried out continuously in the future to collect more data, and hence the accuracy of the model's ability to predict future conditions will continue to improve.

The algorithm used to identify conditions in image operation is a branch of artificial intelligence machine learning, convolution neural network, and the operation method of convolution neural network includes the following:

It consists of multiple layers of convolution layers/ReLU/down sampling;
(1) Convolution: Input the image into the convolution calculation, then perform convolution on the image, input the matrix with pixel values of the image, after cropping, the size of each image is 1280*1280 pixels, and the input matrix is read from the upper left corner of the image to start, next select a smaller matrix, called a filter, and produces a convolution, move with the x and y axis of the input image. The task of the filter is to multiply its value by the original pixel value, multiplications are added to end up with a number. Filter only reads the image in the top left corner, moves further to the right by 1 or N units, and then repeat this process again. When the filter goes through all the positions, a new matrix is obtained with the size of the new matrix smaller than the input matrix. The size of the first layer filter is 32*32 in length*width, the depth is 16, and the number of steps is 2. When it crosses the boundary, it is filled with 0. For the second layer filters, the size of the filter is 32*32 in length*width, 16 in depth, 2 in steps, and filled with 0. The size of the filter in the third layer is 16*16 in length*width, 32 in depth, and 1 in steps, and fill with 0. The length*width of the fourth layer filter is 12*12, the depth is 32, the number of steps is 1, fill with 0. The size of the fifth layer filter is 8*8 in length*width, and the depth is 64, the number of steps is 1, filled with 0. The size of the sixth layer filter in length*width is 4*4, the depth is 64, the number of steps is 1, filled with 0. The size of the seventh layer filter in length*width is 3*3, the depth is 128, the number of steps is 1, and filled with 0;
(2) ReLU activation: After each convolution operation there is the nonlinear ReLU activation layer. Apply ReLU activation to the matrix. ReLU stands for rectified linear unit, and it is a nonlinear operation, using the equation, f(x)=max(0,x). The purpose of ReLU is to introduce nonlinearity in the calculation, because the calculation and learning are required to be non-negative linear values. The result of this step will be a set of feature maps;
(3) Down sampling: These feature maps are provided to the down sampling aggregation calculation. It reduces the dimension of the matrix, but retains the important information. This step performs the data maximum down sampling aggregation calculation. The step retrieves the element with the maximum value in the ReLU activation feature map, and applies it to all elements. In the first four layers of down sampling, the down sampling window (Pooling Size) is 4*4, and the sliding step is 4. In the last three layers, the down sampling window is 2*2, and the sliding step is 2;
(4) Continuous repetition: Our calculation method is established by a total of 7 layers. If necessary, the number of layers in convolution, ReLU activation, and down sampling can be increased or decreased, until the resulting feature map shows satisfactory key parameters;
(5) Flatten the fully connected layer: After repeating enough times, the feature map is flattened, the matrix of the feature map will be converted into a vector, and sent to form a fully connected layer. Finally, output the fully connected layer with the softmax activation function. The use of SoftMax generates the result of the forward propagation neural network in a probability distribution. Softmax is called a normalized exponential function, the expression is:

$$f : {ℝ}^{K} \to {ℝ}^{K} \\ f ( {z}_{j} ) = \frac{{e}^{{z}_{j}}}{{\sum }_{i = 1}^{k} {e}^{{z}_{i}}} ( j = 1 , 2 , … , k )$$

z1 indicates that the node belongs to the first category, and zk indicates that the node belongs to the kth category;
(6) Results: After the activation function is applied to the fully connected layer, the results are classified into different types of operating conditions 1 to N.

Results of this convolution neural network calculation are sent to the computing engine for further artificial intelligence machine learning regression analysis calculations.

Machine learning is specifically a predictive modeling technique, and the main objective is to minimize the error of the model, and to make the most accurate prediction possible. Machine learning algorithms are described as learning target predictive model that can be used to predict output data based on future input data. Through the training of a large amount of previous data, the machine learning model continues to learn and improve its accuracy in predicting the output data from future new input data.

The algorithm applied, regression analysis, is one of the branches of artificial intelligence machine learning. We use a combination regression analysis with algorithms, comprising: 1) single variable regression, 2) multi variable regression, 3) linear regression, and 4) nonlinear regression.

In general, we can express the predictive function F(X) for the combination regression analysis as:
Y=F(X1, X2, . . . , Xn),
series of function output=Y,
series of input data from Sensor 1=X1,
series of input data from Sensor 2=X2,
series of input data from Sensor N or required gases output level=Xn.

Sensors 1 . . . . N can be the liquid content sensors, temperature sensors, liquid pressure sensors, gas pressure sensors, gas flow sensors, voltage sensors, current sensors, cameras, resistivity sensors, and optical liquid clearness sensors. X1 to Xn are the data from the sensors, the results from the convolution neural network calculations, or the required gases output level.

In processing liquid content, temperature, pressure, gas flow, height distance, voltage, or current, if the data are within an accepted range, then Xn is set to 1, otherwise it is set to 0.

In processing the operating condition results from the artificial intelligence convolution neural network image calculation, if the condition is 1, then set Xn to 1*1000. If condition is 2, then set Xn to 2*1000. If condition is n, then set Xn to n*1000.

When training the model, series of input data X1, X2, . . . . Xn and the “commonly well accepted” series of function outputs Y are collected as training data and fed into the model.

In our combination regression analysis, we first analyze the series of input data X1, X2, . . . . Xn, break the series of input data into different input data range, divide the predictive function into different sub predictive functions Y1, Y2, . . . . Yk to cover for different segments of input data ranges. Over the whole input data range, predictive function F(X) is a combined result of all the sub predictive functions covering each of the input data range.

First, each series of input data of X1 to Xn is sorted into an ascending order. Express the first data point of series of input data X1 as X1.1, and the m th data point of series of input data X1 as X1.m. The increment in each input data Xn is compared to the increment in series of function output Y.

Express the increment from the 1^{st} X1 data point to the 2^{nd} X1 data point as

$$dX 1.2 = X 1.2 - X 1.1 , \\ dX 1.3 = X 1.3 - X 1.2 , … \\ dX 1. m = X 1. m - X 1. m - 1$$

Express the increment in series of function output Y, as X1 data point moves from X1.1 to X1.m, and series of function output moves from Y1.1 to Y1.m, as

$$dY 1.2 = Y 1.2 - Y 1.1 , … \\ dY 1.3 = Y 1.3 - Y 1.2 , … \\ dY 1. m = Y 1. m - Y 1. m - 1$$

Express the increment in the Slope as X1 data point moves from X1.1 to X1.m as

$$Slope 1.2 = dY 1.2 / dX 1.2 , \\ Slope 1.3 = dY 1.3 / dX 1.3 , … \\ Slope 1. m = dY 1. m / dX 1. m$$

Repeat these steps for all series of input data from X1 to Xn, whenever detect a significant change in the Slope value, form a new set of input data for this segment of data input range, and group each set of input data for each segment of input data range to form a separate sub predictive function. Submit each set of input data for each sub predictive function for training and for predicting future series of function outputs to multiple regression algorithms, comprising: least-square linear regression algorithm, least-square non-linear regression algorithm, regression neural network algorithm, and other equivalent regression algorithm.

First submit series of input data to the least-square linear regression algorithm, as an example, in the case of single variable, the series of function output y can be expressed as:

$${y}_{i} = α + β {x}_{i} + {ε}_{i} , \\ \hat{β} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \\ \hat{α} = \overline{y} - \hat{β} \overline{x}$$

The general case for multiple variables linear regression can be obtained by similar method.

Second, submit each set of data to a least-square non-linear regression algorithm, as an example, in the case of single variable, the predictive function can be expressed with the same set of equations as in the above linear regression with the exception of replacing xᵢ with one or more higher order factors of the square, the cube, or higher order of self multiple of xᵢ. The general case for multiple variables non-linear regression can be obtained by similar method.

Third, submit each set of data to a regression neural network algorithm, where the steps are as follows:

First, define L-layers of neural layers with a number of neurons in the neural network model, where a neural layer is repeated multiple L times until we get satisfactory results with our input data. Input data X1 to Xn to the first neural layer, and data is moved forward from one neural layer to the next neural layer. Define each layer to contain N neurons where N is set in the first neural layer to be the same as the number of input sensors or more. Define the number of neurons in each subsequent layer, and the number can drop by 0% to 50% from previous layer based on the success in processing the data. Define ReLU activation layer in order to apply nonlinear operation with rectified linear unit ReLU to the data after each neural layer operation. Define final layer with one neuron and with a linear activation function for the function output of the regression neural network algorithm.

Outputs from the multiple regression algorithms are fed as inputs to a final multiple variables least-square linear regression model, and the output from this final multiple variables least-square linear regression model is used as the final result for the combination regression analysis.

When training the model, series of input data and the “commonly well accepted” series of function outputs are collected as training data and fed into the model. The prediction function F is calculated and will become more and more accurate. When the model is fully trained with enough training data, the model can be used with future new series of input data to predict the future series of function outputs as the decision parameters.

We build multiple separate models by the above combination regression analysis in predicting a number of series of function outputs Y as decision parameters to control different devices. When the decision parameter Y is greater than a certain value, a control command is send to increase or decrease the liquid flow valve, the gas flow valves, or the enhance gas flow devices.

The first machine learning model controls the liquid flow valve to adjust the flow volume of the liquid conversion solution from the liquid reservoir to the liquid flow controller. The second machine learning model controls the enhance gas flow devices to adjust the gas flow and the gas pressure from the two gas chambers to the gas cleaning cells. The third machine learning model controls the two gas valves that send the gas from the gas cleaning cell to the liquid reservoir or to the external storage. The fourth machine learning model controls the directions of flow of the liquid conversion solution inside the solute diminish device. The fifth machine learning model controls the valves for flushing the built up of unwanted residues and solutes in the system.

When training a machine learning model, more and more sensor data and the “commonly accepted accurate decision parameters” are collected and fed into the model. The prediction function F is calculated and will become more and more accurate. The coefficients C, M1, M2, . . . . Mn will become more and more accurate. When the model is fully trained with enough training data, the model can be used (using function F, coefficient C, M1, M2, . . . . Mn) with new sensor data to predict the future decision parameter.

This method of liquid-to-gas conversion, its design and parameter setting, can be used to utilize artificial intelligence to control the liquid flow, gas flow, liquid pressure, gas pressure, and temperature. The unwanted residues and solutes in the liquid conversion solution are blocked, and the resulting clean liquid conversion solution is converted into final gases. At the side of the electron exchanger facing the gas chamber, gases are directly released into the gas chambers. The power consumed by the conversion cell will be optimized.

This liquid-to-gas conversion method can be used to convert different kinds of liquid conversion solution into different kinds of gases, and can be used to convert liquid water to hydrogen and oxygen gases.

Multiple conversion cells can be stacked vertically and horizontally, see FIG. 3, and they can share some of the components, such as the microprocessor, sensors, cameras, liquid reservoir, gas cleaning cells, or solute diminish device. More conversion cells can be placed in the same physical space to achieve higher gas production level.

### Operation:

In the following example, we describe our method using sea water, with a large amount of unwanted residues and solutes, as the liquid conversion solution to generate hydrogen and oxygen gases, but the principle of our method can be generalized to apply to other types of liquid conversion solutions to generate other types of gases. The following described embodiment is only one of the, but not all, embodiments of our presented method. Based on the embodiments of our presented method, all other embodiments obtained by those of ordinary skill in the art without creative efforts shall fall within the protection scope of our presented method.

Refer to FIG. 1, FIG. 2, and FIG. 4, the anode electron exchanger and cathode electron exchanger are placed in the liquid-to-gas conversion cell, and the conversion cell is separated into, from left to right, the cathode gas chamber 210, the liquid flow controller placed inside the liquid conversion solution chamber 230, and the anode gas chamber 220.

The liquid flow controller 100 is made of a solute diminish layer 130 at one side, a distribution track 150 next to the solute diminish layer, and a liquid control sheet stack next to the distribution track. See FIG. 1. The liquid control sheet stack is built by stacking together a plurality of nonconductive single sheets 110, 120. Among them, the multiple track injection single sheets 120 are in the middle section, they are protected from the left and right by a mixture of the liquid control single sheets and liquid retention mesh material single sheets 110. The unwanted residues and solutes in the sea water are blocked by this solute diminish layer. Clean water can flows through the solute diminish layer, the distribution track, and the liquid inlets of the multiple track injection single sheets to the rest of the liquid flow controller.

The liquid-to-gas conversion cell is equipped with an intelligent microprocessor (MCU) 310 to carry out artificial intelligence machine learning calculation, monitors and controls various operation parameters of the liquid-to-gas conversion cell.

When necessary, microprocessor controls special valve 371 to bring in ionizing solute potassium hydroxide to the liquid flow controller. Ionizing solute goes through inlets 140 from the side of the liquid flow controller, passes through the solute diminish layer, and goes to the distribution track of the multiple track injection single sheet. The ionizing solute inlets are protected and separated from the solute diminish layer materials. When ionizing solute is added to the water, water is ionized to form the liquid conversion solution.

The electron exchangers 240 and 250 facing the liquid conversion solution chamber and the non-conductive sides are in direct contact with the liquid flow controller. The other conductive side of the electron exchanger faces the gas chamber. The surface of the electron exchanger is covered with puncture channels. Voltage is applied to the cathode and anode electron exchange. At the side of the cathode facing the gas chamber, electrons are released into the water to reduce the water to hydrogen and hydroxide root ions, hydrogen gas is released into the cathode gas chamber. The hydroxide ions from the cathode electron exchanger go through the liquid flow controller, reach the anode electron exchanger 250. At this anode, the hydroxide ions are converted into water, oxygen and electrons. The electrons are collected by the anode, and oxygen gas is released to the anode gas chamber.

Microprocessor is connected to two gas flow fans, acting as the enhance gas flow devices 370, to control the gas flow and the gas pressure coming from the two gas chambers. Gases pass through gas flow sensors 320 to the cathode and anode gas cleaning cells 360. Gas cleaning cells are filled with a gas cleaning liquid 361. Gas bubbles rise from the gas inlets of the gas cleaning cells to the gas outlets at the top of the gas cleaning cells.

From the gas outlets of the gas cleaning cells, select one of the gases to direct through the gas flow sensor 362, and collect it for external storage. Select the other gas as the recycle pressure gas, and this recycle pressure gas is connected to the heat exchanger 340 placed on the outer wall of the liquid-gas converter, and then reaches two gas valves 377, 379 controlled by the microprocessor. One of the gas valves, through the gas flow sensor 378, leads to the external storage. The other gas valve leads to the air-sealed liquid reservoir 382. The gas pressure inside the liquid reservoir pushes the liquid conversion solution 381 from the liquid reservoir to the solute diminish device 374. The unwanted residues and solutes in the seawater are blocked by solute diminish device, and clean water flows through liquid flow sensor 260 to the liquid flow valve 280, and passes through the solute diminish layer 270 at the side of the liquid flow controller 230. The unwanted residue and solute in the seawater are blocked again by the solute diminish layer, and the clean water flows down to the rest of the liquid flow controller.

The solute diminish device is composed of three solute diminish cells. The liquid enters the solute diminish device main inlet 610 and goes to two separate valves 620, leading to the inlet of the first cell 622 or the inlet of the second cell. Liquid leaves the first cell outlet and goes to two separate valves 630, leading to the inlet of the second cell 632 or the inlet of the third cell. Similarly, liquid leaves the second cell outlet and goes to two separate vales 640, leading to the inlet of the third cell 642 and the main outlet of the device 650. Liquid leaves the third cell outlet and goes to the main outlet of the solute diminish device.

Three sets of resistivity sensor, optical liquid clearness sensor, and image cameras 615, 625, 635 are connected to the microprocessor, and each set is located at the inlets of the each of the solute diminish cell. Images of these locations from the cameras are sent to the microprocessor for artificial intelligence image calculation.

A microprocessor and a liquid content sensor monitor the liquid level in the liquid reservoir, and if the liquid level is too low, the microprocessor opens liquid valve 375 to bring in more liquid conversion solution into the reservoir.

When the microprocessor, with the resistivity sensor and optical clearness sensor 373, 615, 625, 635, detects the unwanted residues and solute levels in the liquid conversion solution are too high, it opens the valves 372, 645 at these locations to flush and reduces unwanted residues and solute levels. In addition, the microprocessor controls multiple liquid valves 350 at the bottom of the liquid-to-gas conversion cell, and opens these valves for self-clean flushing when necessary.

The microprocessor is also connected to hygrometer sensors (HGO) 300, liquid content sensors 290, temperature sensors 330, pressure sensors 330, voltage sensor, and current sensor. More sensors can be placed at selected locations within the liquid to gas conversion cell if necessary.

As more gas is produced, the water in the liquid flow controller dries up, and the microprocessor senses the water content situation at this location. In addition, microprocessor and cameras 325 monitors the operating conditions of the electron exchangers and gas chambers. After artificial intelligence calculations, the microprocessor will increase or decrease the liquid flow valve 280, allowing more or less water from the liquid reservoir to flow into the liquid flow controller.

Therefore, microprocessor controls the liquid and gas flow volume, the pressure and the temperature inside the liquid-to-gas conversion cell. The result of our conversion method provides an energy efficient liquid-to-gas conversion method to generate hydrogen and oxygen gases from sea water with a large amount of unwanted residues and solutes.

### CONCLUSION, RAMIFICATIONS, AND SCOPE

While the above description contains much specificity, these should not be construed as limitations on the scope of the invention, but rather as an exemplification of one preferred embodiment thereof. Many other variations are possible.

For example, we describe our method using an example of water as liquid conversion solution to generate hydrogen and oxygen gases, but the principle of our method can be generalized to apply to other types of liquid conversion solutions to generate other types of gases.

For example, we describe our method in manufacturing the puncture channels using precision technologies, comprising: chemical etching, plasma etching, laser drilling or electroforming. The puncture channels can possibly be manufactured by other kinds of technologies that are not listed in our described list of technologies, but the principle of our method can be generalized to apply to manufacturing the puncture channels with technologies that are able to create similar small openings.

For example, we describe our machine learning regression method by using a linear regression method as an illustration, but the principle of our regression method can be generalized to applying a combination of 1) single variable regression, 2) multi variable regression, 3) linear regression, and 4) nonlinear regression.

The described embodiment in the above description is only one of the, but not all, embodiments of our presented method. Based on the embodiments of our presented method, all other embodiments obtained by those of ordinary skill in the art without creative efforts shall fall within the protection scope of our presented method.

The scope of the invention should be determined not by the embodiments illustrated, but by the appended claims and their legal equivalents.

I claim:

1. A method for artificial intelligence image monitoring recycled pressure solute diminished conversion of liquid to gas, comprising:
placing a liquid flow controller in a liquid conversion solution chamber inside a conversion cell;
feeding liquid conversion solution through a solute diminish device to said liquid flow controller in said liquid conversion solution chamber inside said conversion cell;
placing electron exchangers, built with one or more puncture channels, in said conversion cell, comprising: cathode electron exchanger, and anode electron exchanger;
setting gas chambers in said conversion cell, comprising: cathode gas chamber, and anode gas chamber;
placing said electron exchangers in between said liquid conversion solution chamber and said gas chambers inside said conversion cell;
enabling said liquid conversion solution passing from said liquid flow controller through said one or more puncture channels of said electron exchangers;
applying a voltage to said anode electron exchanger and said cathode electron exchanger;
converting said liquid conversion solution into gases releasing to said gas chambers in said conversion cell; and
building said liquid flow controller by placing structures selected from any combination of one or more options, comprising:
placing a solute diminish layer at one side of said liquid flow controller,
placing a distribution track next to said solute diminish layer in said liquid flow controller, and
placing a liquid control sheet stack next to said distribution track in said liquid flow controller.

2. The method of claim 1 wherein said placing said electron exchangers in said conversion cell further comprises:
using said electron exchangers with one side conductive and one side nonconductive in said conversion cell;
placing said nonconductive sides of said electron exchangers facing said liquid flow controller in said liquid conversion solution chamber and in contact with said liquid conversion solution in said liquid flow controller;
placing said conductive side of said cathode electron exchanger facing said cathode gas chamber; and
placing said conductive side of said anode electron exchanger facing said anode gas chamber.

3. The method of claim 1 wherein said placing said liquid flow controller in said liquid conversion solution chamber further comprises:
building said liquid flow controller by actions selected from any combination of one or more options, comprising:
building said solute diminish layer by stacking structures selected from any combination of one or more options, comprising: stacked graphene sheets, stacked graphene oxide sheets, stacked polymer particles coated with graphene, and stacked polymer sheets with small pores;
placing one or more ionizing solute inlets passing through said solute diminish layer, enabling necessary ionizing solute to flow through said ionizing solute inlets and pass through said solute diminish layer;
placing said distribution track to distribute said liquid conversion solution evenly across said liquid control sheet stack;
building said liquid control sheet stack by stacking single sheets selected from any combination of one or more options, comprising: multiple track injection single sheet, liquid control single sheet, and liquid retention mesh material single sheet;
building said multiple track injection single sheet with one or more tracks and one or more puncture channels on the surface to form a network of distribution channels to distribute said liquid conversion solution from liquid inlets of said multiple track injection single sheet to locations across said multiple track injection single sheet and to pass through;
building said liquid control single sheet with one or more puncture channels on the surface for said liquid conversion solution to pass through;
building said liquid retention mesh material single sheet using mesh materials with small pores for said liquid conversion solution to pass through;
building said single sheets and stacking said single sheets to follow design parameters and to control rate and amount of said liquid conversion solution in passing through said liquid flow controller;
setting one or more said puncture channels from adjacent said single sheets to be out of alignment with each other, forming a pattern of interlocking said puncture channels in between adjacent said single sheets; and
enabling said solute diminish layer to block unwanted solute residue in said liquid conversion solution from flowing through said solute diminish layer to said liquid flow controller.

4. The method of claim 1 wherein said feeding said liquid conversion solution to said liquid flow controller further comprises:
feeding said liquid conversion solutions by actions selected from any combination of one or more options, comprising:
placing said liquid conversion solution in a liquid reservoir and feeding said liquid conversion solution from said liquid reservoir through said solute diminish device built with diminish cells selected from any combination of one or more options, comprising: coarse diminish cell, fine diminish cell, and extreme fine diminish cell;
placing additional diminish cells if necessary in said solute diminish device;
feeding said liquid conversion solution through a liquid valve from said solute diminish device to said liquid flow controller in said liquid conversion solution chamber;
feeding said gases from gas chamber outlets of said gas chambers to gas cleaning cells filled with gas cleaning liquid;
adjusting physical parameters, at any combination of one or more locations of said conversion cell, said gas cleaning cells, said liquid reservoir, and said solute diminish device, for any combination of one or more parameter options, comprising: temperature, liquid pressure, gas pressure, liquid flow rate, and gas flow rate;
filling said coarse diminish cell with materials selected from any combination of one or more options, comprising: sand, pebbles, and equivalent materials;
feeding said liquid conversion solution from said liquid reservoir through a liquid valve to said coarse diminish cell and through a separate liquid valve to bypass said coarse diminish cell to liquid outlet of said coarse diminish cell;
filling said fine diminish cell with materials selected from any combination of one or more options, comprising: graphite, charcoal, and equivalent materials;
feeding said liquid conversion solution from liquid outlet of said coarse diminish cell through a liquid valve to said fine diminish cell and through a separate liquid valve to bypass said fine diminish cell to liquid outlet of said fine diminish cell;
filling said extreme fine diminish cell with materials selected from any combination of one or more options, comprising: graphene sheets, graphene oxide sheets, and equivalent materials; and
feeding said liquid conversion solution from liquid outlet of said fine diminish cell through a liquid valve to said extreme fine diminish cell and through a separate liquid valve to bypass said extreme fine diminish cell to liquid outlet of said extreme fine diminish cell.

5. The method of claim 4 wherein said adjusting physical parameters at any combination of one or more locations, further comprises:
feeding said gases by actions selected from any combination of one or more options, comprising:
selecting one of said gases as recycled pressure gas released from one of said gas chambers;
feeding said recycled pressure gas from one of said gas cleaning cells to a heat exchange device that is placed along the outside wall of said conversion cell;
feeding said recycled pressure gas from said heat exchange device through a recycle gas valve to said liquid reservoir;
enabling said recycle gas valve to control amount and rate of said recycled pressure gas flowing to said liquid reservoir to adjust gas pressure inside said liquid reservoir;
feeding said recycled pressure gas from said heat exchange device through a external gas valve to an external gas storage; and
enabling said external gas valve to control amount and rate of said recycled pressure gas flowing to said external gas storage.

6. The method of claim 4 wherein adjusting physical parameters at any combination of one or more locations further comprises:
placing control or sensing devices at significant placement locations selected from any combination of one or more options, comprising: locations inside or around said conversion cell, locations inside or around said gas cleaning cells, locations inside or around said liquid reservoir, and locations inside or around said solute diminish device;
placing said control or sensing devices by actions selected from any combination of one or more options, comprising:
placing valves, at any combination of one or more said significant placement locations, from any combination of one or more options, comprising: liquid valves, and gas valves;
placing enhance gas flow devices to adjust gas flow at any combination of one or more said significant placement locations;
placing sensors, at any combination of one or more said significant placement locations, from any combination of one or more options, comprising: cameras, resistivity sensors, optical clearness sensors, liquid content sensors, temperature sensors, liquid pressure sensors, gas pressure sensors, liquid flow sensors, gas flow sensors, voltage sensors, and current sensors;
placing said liquid valve in front of liquid inlet to said solute diminish device and controlling flushing of unwanted residues and solutes to external disposal;
placing said liquid valve in between outlet from said solute diminish device and liquid inlet to said liquid flow controller, controlling flushing of unwanted residues and solutes to external disposal;
placing said liquid valve at bottom liquid outlet of said liquid flow controller and controlling flushing of unwanted residues and solutes to external disposal;
placing said resistivity sensor, said optical clearness sensor, and said camera to monitor status of said liquid conversion solution going through the inlet to said solute diminish device;
placing said resistivity sensor, said optical clearness sensor, and said camera to monitor status of said liquid conversion solution going through the inlet to said coarse diminish cell;
placing said resistivity sensor, said optical clearness sensor, and said camera to monitor status of said liquid conversion solution going through the inlet to said fine diminish cell;
placing said resistivity sensor, said optical clearness sensor, and said camera to monitor status of said liquid conversion solution going through the inlet to said extreme fine diminish cell;
placing said resistivity sensor, said optical clearness sensor, and said camera to monitor status of said liquid conversion solution going through the inlet to said liquid flow controller;
placing said liquid valve at liquid inlet of said liquid flow controller and controlling amount and rate of said liquid conversion solution flowing to said liquid flow controller;
placing said liquid content sensor at liquid inlet side of said liquid flow controller;
placing said liquid content sensor at middle area of said liquid flow controller;
placing said liquid content sensor at bottom of said cathode gas chamber;
placing said liquid content sensor at bottom of said anode gas chamber;
placing said liquid content sensor in said liquid reservoir;
placing said temperature sensor in said liquid reservoir;
placing said gas pressure sensor in said liquid reservoir;
placing said temperature sensors in said gas chambers and said liquid conversion solution chamber;
placing said gas pressure sensors in said gas chambers;
placing said liquid pressure sensor in said liquid conversion solution chamber;
placing said voltage sensor to measure voltage applied across said cathode electron exchanger and said anode electron exchanger;
placing said current sensor to measure current applied across said cathode electron exchanger and said anode electron exchanger;
placing said gas flow sensor at gas external outlet from said external gas valve to said external gas storage;
placing said gas flow sensors at said gas chamber outlets of said gas chambers;
placing said enhance gas flow devices at said gas chamber outlets of said gas chambers; and
placing said cameras facing said electron exchangers to monitor status of generation of said gases releasing to said gas chambers.

7. The method of claim 6 wherein said placing control or sensing devices further comprises:
using a computing engine by combining computing capabilities with computing devices selected from any combination of one or more options, comprising: microprocessors, local based computers connected by networks, and cloud based computers connected by Internet;
using said computing engine to carry out actions from any combination of one or more options, comprising:
using said computing engine to exchange data with or to control devices selected from any combination of one or more options, comprising: said sensors, said valves, and said enhance gas flow devices; and
enabling results from said computing engine to be read by operators in any combination of one or more remote locations through mobile phones and computer tablets.

8. The method of claim 7 wherein said using said computing engine to exchange data with or to control devices further comprises:
using operation images or data from said cameras or said sensors as inputs to said computing engine to carry out artificial intelligence calculations;
carrying out said artificial intelligence calculation using machine learning convolution neural network to recognize operating conditions from said operation images with steps selected from any combination of one or more options, comprising:
step 1 convolution: inputting images into convolution calculation, then performing convolution on images, inputting matrix with pixel values of images, after cropping, changing size of each image, and reading input matrix from upper left corner of image to start, selecting a smaller matrix called filter, producing convolution filter, moving with x and y axis of input image, setting task of filter to multiply its value by original pixel value, adding all these multiplications and ending up with a number, setting filter to read image in top left corner, moving further to right by 1 or N units, and repeating this process again, after filter going through all positions, obtaining a new matrix with size of new matrix smaller than input matrix, setting size of first layer filter in length*width, depth, and number of steps, filling with a value when crossing boundary, repeating setting size of second layer, third layer to seventh layer filters in length*width, depth, steps, and filling with a value;
step 2 ReLU activation: applying nonlinear operation with rectified linear unit ReLU activation layer to matrix after each convolution operation, using equation, f(x)=max(0,x), introducing nonlinearity in calculation with ReLU, generating a resulting set of feature maps;
step 3 down sampling: down sampling calculation with feature maps, reducing dimension of matrix, but retaining important information, performing maximum data down sampling aggregation calculation, retrieving maximum value element in ReLU activation feature map, and applying it to all elements, setting down sampling window size length*width and sliding step value of each layer;
step 4 repetition: increasing or decreasing number of layers, repeating steps in convolution calculation, ReLU activation, and down sampling;
step 5 flatten fully connected layer: flattening feature map after repeating enough times, converting matrix of feature map into vector, sending to form a fully connected layer, outputting fully connected layer with softmax activation function, generating result of forward propagation neural network in probability distribution, setting softmax as a normalized exponential function with an expression as:
$$f : {ℝ}^{K} \to {ℝ}^{K} , \\ f ( {z}_{j} ) = \frac{{e}^{{z}_{j}}}{{\sum }_{i = 1}^{k} {e}^{{z}_{i}}} ( j = 1 , 2 , … , k ) ,$$
letting z1 indicate that node of first category, and zk indicate node of kth category;
step 6 getting results: after applying activation function to fully connected layer, classifying results into one or more types of said operating conditions 1 to N; and
sending results of said convolution neural network to said computing engine to carry out further calculation.

9. The method of claim 7 wherein said using said computing engine to exchange data with or to control devices further comprises:
using said computing engine to carry out combination regression analysis with series of input data feeding from said sensors;
carrying said combination regression analysis with actions selected from any combination of one or more options, comprising:
expressing a predictive function F(X) for said combination regression analysis as:
Y=F(X1, X2, . . . , Xn),
series of function output=Y,
series of input data from Sensor 1=X1,
series of input data from Sensor 2=X2, . . .
series of input data from Sensor N, results of said convolution neural network, or required gases output level=Xn;
setting Xn to 1 when a selected said input data is within an acceptable range and setting Xn to 0 when a selected said input data is out of said acceptable range;
setting Xn to a value when results of said convolution neural network is one particular said operating condition, and setting Xn to a different value when results of said convolution neural network is a different said operating condition;
training said combination regression analysis to become more accurate by feeding training data, including said series of input data and commonly well accepted values for said series of function output, into said combination regression analysis;
sorting each said series of input data of X1 to Xn into an ascending order, expressing the first data point of said series of input data X1 as X1.1, the m th data point of said series of input data X1 as X1.m;
calculating the increment in slope, as said series of input data moves from X1.1 to X1.m and said series of function output moves from Y1.1 to Y1.m, by dividing the increment in said series of function output, as Y1.1 moves to Y1.m, by the increment in each input data, as X1.1 moves to X1.m, and repeating these steps for all said series of input data from X1 to Xn;
detecting a significant change in the slope value to form a set of input data for this segment of data input range, grouping each said set of input data for each said segment of data input range to form a separate sub predictive function;
setting said predictive function F(X) covering the whole input data range as a combined result of all said sub predictive functions covering each said segment of data input range inside said whole input data range;
feeding each said set of input data for each said sub predictive function covering each said segment of data input range to multiple regression algorithms selected from any combination of one or more regression algorithms, comprising: least-square linear regression algorithm, least-square non-linear regression algorithm, regression neural network algorithm, and other equivalent regression algorithm;
feeding each said set of data for each said sub predictive function to said least-square linear regression algorithm to obtain said series of function output, where in the case of single variable, expressing said series of function output as yi, where:
$${y}_{i} = α + β {x}_{i} + {ε}_{i} , \\ \hat{β} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \\ \hat{α} = \overline{y} - \hat{β} \overline{x} ,$$
and obtaining said series of function output for the general case for multiple variables linear regression by similar methods;
feeding each said set of data for each said sub predictive function to said least-square non-linear regression algorithm, using the same set of equations as in said least-square linear regression and by replacing input xᵢ with one or more higher order factors of self multiple of xᵢ to obtain said series of function output, and obtaining said series of function output for the general case for multiple variables non-linear regression by similar methods;
feeding each said set of data for each said sub predictive function to said regression neural network algorithm with steps as follows: defining a neural layer with neurons in said regression neural network algorithm, repeating to add defining said neural layer one or more times until reaching satisfactory results, inputting said series of input data X1 to Xn to the first said neural layer, moving data forward from one said neural layer to the next said neural layer, setting each said neural layer to contain N said neurons, setting N in the first said neural layer to be the same as or more than the number of said sensors, setting the number of said neurons in each subsequent said neural layer to decrease by zero to a percentage from previous layer, applying nonlinear operation with rectified linear unit ReLU to the data after each said neural layer operation, setting final said neural layer with one said neuron and with a linear activation function for said series of function output of said regression neural network algorithm;
taking said series of function outputs from one or more regression algorithms from said multiple regression algorithms as inputs feeding to a final multiple variables least-square linear regression model, using series of function output from said final multiple variables least-square linear regression model as series of function output for said combination regression analysis;
feeding future new said series of input data to said combination regression analysis in predicting future said series of function outputs, after said combination regression analysis is fully trained to become an accurate model; and
using said future said series of function outputs from said combination regression analysis to determine commands to send to control said sensors, said valves, or said enhance gas flow devices.

10. The method of claim 3 wherein said building said single sheets and stacking said single sheets to follow design parameters, further comprises actions selected from any combination of one or more options, comprising:
modeling said liquid conversion solution adhering on surfaces of said single sheets as droplets and diffusing until a partial wetting equilibrium contact radius is reached;
expressing said droplets with radius r as:
$$r = \sqrt{\frac{V}{π h}} , where h = \sqrt{\frac{2 σ ( 1 - cos θ )}{ρ g}} ,$$
σ is surface tension,
g is gravitational acceleration constant,
θ is contact angle between liquid and surface,
h is height of droplet,
V is time function of volume of droplet;
expressing said droplet with said radius over time r(t) as:
$$r ( t ) = {{r}_{e} [ 1 - exp ( - ( \frac{2 {γ}_{LG}}{{r}_{e}^{12}} + \frac{ρ g}{9 {r}_{e}^{10}} ) \frac{24 γ {V}^{4} ( t + {t}_{0} )}{{π}^{2} η} ) ]}^{\frac{1}{6}} ;$$
expressing said droplet with said radius over time r(t), by assuming perfect spreading of said droplets and a delay time, as:
$$r ( t ) = {[ {( {γ}_{LG} \frac{96 λ {V}^{4}}{{π}^{2} η} ( t + {t}_{0} ) )}^{\frac{1}{2}} + {( \frac{λ ( t + {t}_{0} )}{η} )}^{\frac{2}{3}} \frac{24 ρ {gV}^{\frac{3}{8}}}{7 \cdot {96}^{\frac{1}{3}} {π}^{\frac{4}{3}} {γ}_{LG}^{\frac{1}{3}}} ]}^{\frac{1}{6}} ,$$
γLG is surface tension of liquid,
V is droplet volume,
η is viscosity of liquid,
ρ is density of liquid,
g is gravitational acceleration constant,
λ is shape factor, 37.1 m-1,
t0 is experimental delay time,
re is radius of droplet at equilibrium;
making distances between adjacent one or more said puncture channels of said single sheets as a multiple of said radius over time r(t);
making radii of one or more said puncture channels of said single sheets no bigger than said radius over time r(t);
making radii of said pores of said liquid retention mesh material single sheets no bigger than said radius over time r(t);
making width of said tracks of said multiple track injection single sheets as a multiple of said radius over time r(t);
adjusting said width of said tracks of same said multiple track injection single sheet to one or more values depending on locations of said tracks on same said multiple track injection single sheet;
adjusting said distances between adjacent said puncture channels of same said single sheet and said radii of said puncture channels of same said single sheet to one or more values depending on locations of said puncture channels on same said single sheet; and
adjusting said distances between adjacent one or more said puncture channels of said single sheets, said radii of one or more said puncture channels of said single sheets, said radii of said pores of said liquid retention mesh material single sheets, and said width of said tracks of said multiple track injection single sheets based on physical parameters, at any combination of one or more locations of said conversion cell, from any combination of one or more parameter options, comprising: temperature, liquid pressure, gas pressure, and gas flow rate.

11. The method of claim 3 wherein said building said single sheets and stacking said single sheets to follow design parameters, further comprises actions selected from any combination of one or more options, comprising:
expressing height h of a liquid column as:
$$h = \frac{2 γ cos θ}{ρ g r} ,$$
γ is liquid-air surface tension coefficient (force/unit length),
θ is contact angle,
ρ is density of liquid,
g is gravitational acceleration constant,
r is said radius over time r(t);
making thickness of one or more said puncture channels of said single sheets no thicker than said height h;
making spacing between adjacent said single sheets be no larger than said height h; and
adjusting said thickness of said single sheets and said spacing between adjacent said single sheets based on physical parameters, at any combination of one or more locations of said conversion cell, from any combination of one or more parameter options, comprising: temperature, liquid pressure, gas pressure, and gas flow rate.

12. The method of claim 3 wherein said building said single sheets to follow design parameters, further comprises:
making one or more said puncture channels of said multiple track injection single sheets and said liquid control single sheets having design patterns from any combination of one or more options, comprising: Y-shaped, X-shaped, and star-shaped design pattern.

13. The method of claim 3 wherein said building said single sheets to follow design parameters further comprises:
manufacturing said liquid retention mesh materials single sheets by a precision material woven technology;
manufacturing said multiple track injection single sheets and said liquid control single sheets with a precision technology selected from any combination of one or more options, comprising:
manufacturing said multiple track injection single sheets and said liquid control single sheets in a similar way as manufacturing said electron exchangers with said puncture channels;
chemical etching by applying chemicals to etch away specific points of material to form one or more said tracks and one or more said puncture channels;
plasma etching by applying plasma to etch away specific points of material to form one or more said tracks and one or more said puncture channels;
laser drilling by repeatedly applying a pulsing focused laser to material to cut away specific spots to form one or more said tracks and one or more said puncture channels; and
electroforming by electro depositing of material onto a mandrel to form one or more said tracks and one or more said puncture channels.

14. The method of claim 1 wherein said converting said liquid conversion solution into said gases in said conversion cell further comprises with actions selected from any combination of one or more options, comprising:
converting one or more kinds of said liquid conversion solution into one or more kinds of said gases;
converting liquid water into hydrogen gas and oxygen gas;
stacking two or more said conversion cells vertically and horizontally; and
sharing common components among said two or more said conversion cells.
